(19) United States
(12) Patent Application Publication
(10) Pub. No.: US 2006/0273059 A1
(43) Pub. Date: Dec. 7, 2006

(54) MODULAR INFANT FEEDING BOTTLE

(75) Inventors: Andrew Mendenhall, Mooresville, IN (US); Paul T. Zink, Indianapolis, IN (US); Dennis M. Turner, Mooresville, IN (US)

Correspondence Address: BARNES & THORNBURG LLP, 11 SOUTH MERIDIAN, INDIANAPOLIS, IN, 46204, US

(73) Assignee: CATALYST PDG, INC., Indianapolis, IN (US)

(21) Appl. No.: 11/275,581

(22) Filed: Jan. 17, 2006

Related U.S. Application Data
(60) Provisional application No. 60/645,208, filed on Jan. 19, 2005.

(51) Int. Cl. A61J 11/00; A61J 9/00; A61J 9/08; B65D 23/12

(52) U.S. Cl. 215/11.1; 215/11.4; 215/11.6; 215/396; 215/386

(57) ABSTRACT

A liquid-dispensing bottle includes a container and a liquid dispenser closing an open mouth of the container. The container includes several components that can be selected and assembled by a user to produce either a small-volume baby bottle or a large-volume baby bottle.

This application claims priority under 35 U.S.C. §119(e) to U.S. Provisional Application Ser. No. 60/645,208, filed Jan. 19, 2005, which is expressly incorporated by reference herein.

### BACKGROUND

The present disclosure relates to infant feeders, and particularly to bottles for dispensing liquids to infants. More particularly, the present disclosure relates to small and large baby bottles.

### SUMMARY

According to the present disclosure, a liquid-dispensing bottle comprises a container and a liquid dispenser closing an open mouth of the container. In an illustrative embodiment, the container includes several components that can be selected and assembled by a user to produce either a small-volume (e.g., four ounce) baby bottle or a large-volume (e.g., eight ounce) baby bottle. This container “kit” comprises two “short” sleeves and a connector ring for interconnecting the two short sleeves to produce one tall sleeve in a first embodiment of the present disclosure. In a second embodiment of the present disclosure, a first short sleeve is configured to mate with a second short sleeve to produce one tall sleeve. Using such a container kit, a user can elect to use either (1) only one of the short sleeves to produce a small-volume baby bottle or (2) both of the short sleeves to produce a large-volume baby bottle. In either case, the liquid dispenser is mounted on top of a short sleeve to close the open mouth thereof.

In illustrative embodiments, a bottom closure is also included in the liquid-dispensing bottle in accordance with the present disclosure. Such a bottom closure can be formed to mate with either one of the short sleeves to close a bottom opening formed therein. Alternatively, one of the short sleeves could be formed monolithically to include a bottom closure.

In illustrative embodiments, the liquid-dispensing bottle further comprises a holder adapted to be gripped by an infant to retain the container at about the predetermined angle during feeding. The holder includes, for example, a mount ring configured to mate with the container and a pair of grip handles. In one embodiment, the mount ring is coupled to one of the short sleeves to lie at a “top” of the container. In another embodiment, the mount ring is coupled to one of the short sleeves to lie at a “mid-section” of the container. Each grip handle is cantilevered to the mount ring and arranged to extend at an acute angle with respect to a “horizontal plane” established by the mount ring.

In other illustrative embodiments, the liquid dispenser can take many forms. For example, the liquid dispenser could include either a lid, spout, nipple, or straw holder.

In other illustrative embodiments, the liquid-dispensing bottle further comprises a cap configured to mount on and cover exposed portions of the liquid dispenser. The cap includes, for example, a shell formed to include an interior region receiving portions of the liquid dispenser therein. The cap also includes a drip container coupled to the shell and arranged to lie in the interior region and mate with, for example, a nipple defined by the liquid dispenser while the shell is mounted on the liquid dispenser so that any liquid discharged from the nipple inadvertently is retained in the drip container while the cap is in place on the liquid dispenser.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a “short” liquid-dispensing bottle in accordance with the present disclosure showing a bottle including a cap, a liquid dispenser, a bottom closure, and only one “short” sleeve;

FIG. 2 is a perspective view of the short sleeve included in the bottle shown in FIG. 1 that suggests that the sleeve is formed to include, at one end, a threaded top collar formed to include a top opening and, at an opposite end, a threaded bottom collar formed to include a bottom opening;

FIG. 3 is a perspective view of a short sleeve in accordance with another embodiment of the present disclosure wherein the sleeve is formed to include, at one end, a threaded top collar formed to include a top opening, and at an opposite end, a floor providing a base;

FIG. 4 is an exploded perspective assembly view of components that can be assembled to produce the short liquid-dispensing bottle of FIG. 1 or a tall liquid-dispensing bottle of the type shown in FIG. 5 showing a container comprising separate upper and lower sleeves, a connector ring for interconnecting the upper and lower sleeves, and a bottom closure including a valve and a valve base, a holder including a mount ring and a pair of grip handles coupled to the mount ring, a liquid dispenser including a nipple and a nipple mount, and a cap comprising a shell and a drip container depending from a ceiling of the shell, and also showing an alternative orientation of the holder (relative to the container) and three alternative configurations of the liquid dispenser;

FIG. 5 is a sectional view of a tall liquid-dispensing bottle assembled using components illustrated in FIG. 4 and showing use of a connector ring to interconnect upper and lower short sleeves;

FIG. 6 is a perspective view of a modular bottle in accordance with another embodiment of the present disclosure showing an upper short sleeve mated with a lower short sleeve to establish a mid-section of a tall container and a mount ring of a holder coupled to the lower short sleeve and located at the mid-section of the tall container; and

FIG. 7 shows several liquid-dispensing bottles wherein each bottle is made using a kit of components in accordance with the present disclosure.

### DETAILED DESCRIPTION

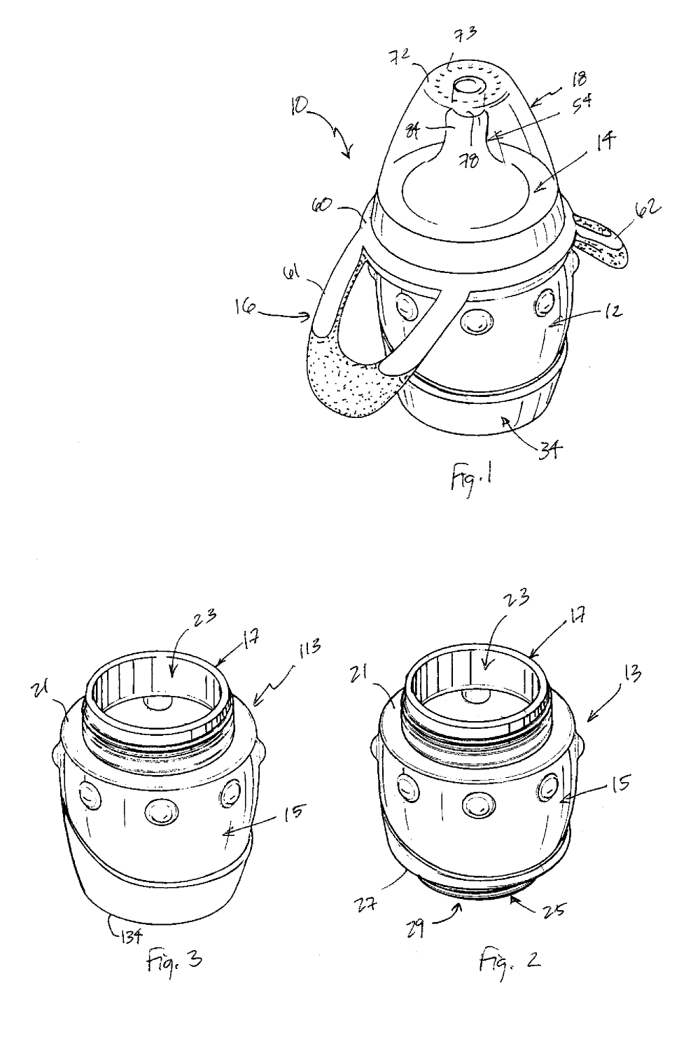

A liquid-dispensing bottle 10 includes a container 12, a liquid dispenser 14 coupled to a top end of container 12, and a bottom closure 34 coupled to a bottom end of container 12 as suggested in FIG. 1. Bottle 10 also includes a holder 16 interposed between container 12 and liquid dispenser 14, and a cap 18 mounted on liquid dispenser 14.

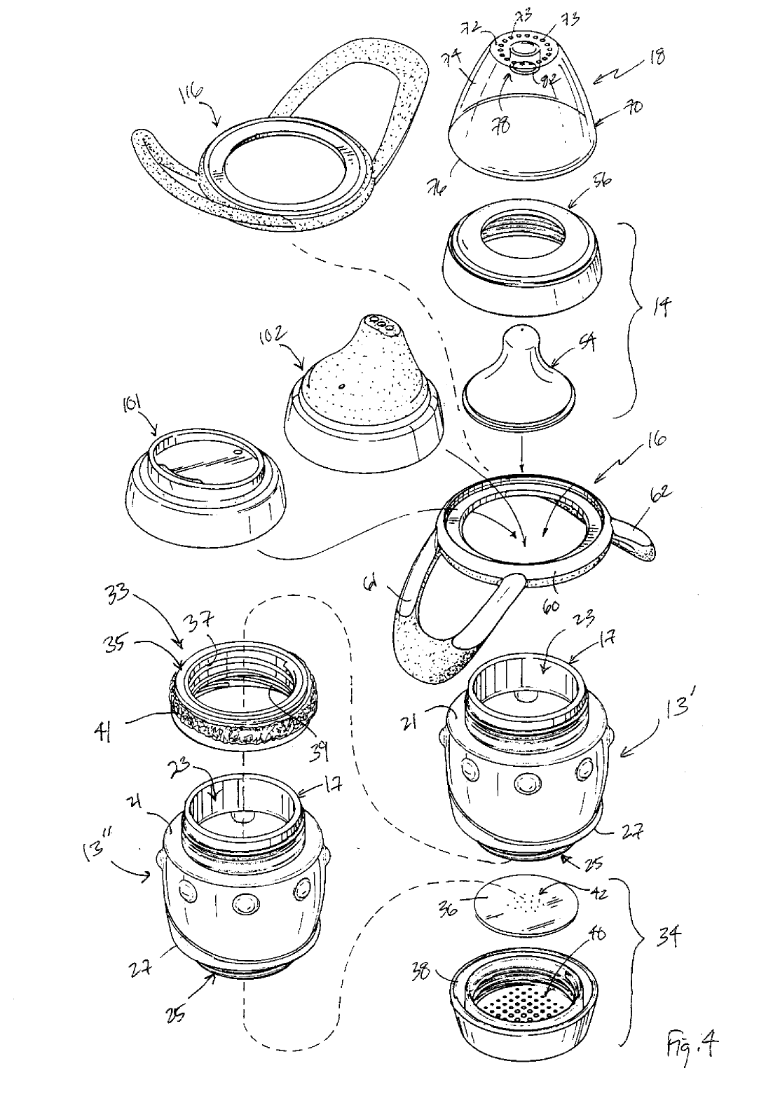

Container 12 is established by a short sleeve 13 in one illustrative embodiment as shown in FIG. 2. Short sleeve 13 includes a somewhat barrel-shaped side wall 15 and an externally threaded top collar 17 appended to a top end 21 of barrel-shaped side wall 15 and formed to include a top opening 23. Short sleeve 13 also includes an externally threaded bottom collar 25 appended to a bottom end 27 of bartel-shaped side wall and formed to include a bottom opening 29.

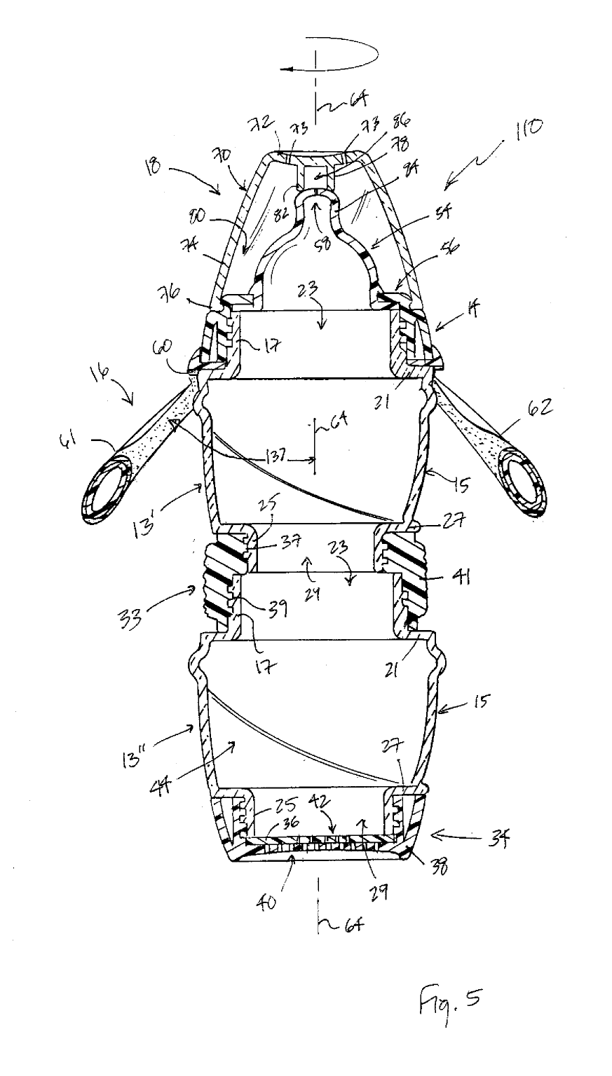

In an alternative embodiment illustrated in FIG. 3, container 12 is established by short sleeve 113. Short sleeve 113 includes a barrel-shaped side wall 15 and an externally threaded top collar 17 appended to a top end 21 of barrel-shaped side wall 15. Short sleeve 113 also includes a floor or bottom wall 134 coupled integrally to a bottom end of barrel-shaped side wall 15. In other words, short sleeve 113 is a monolithic element comprising side wall 15 and bottom wall 134. It is within the scope of this disclosure to form a short liquid-dispensing bottle (similar to bottle 10) using short sleeve 113 instead of short sleeve 13 and bottom closure 34.

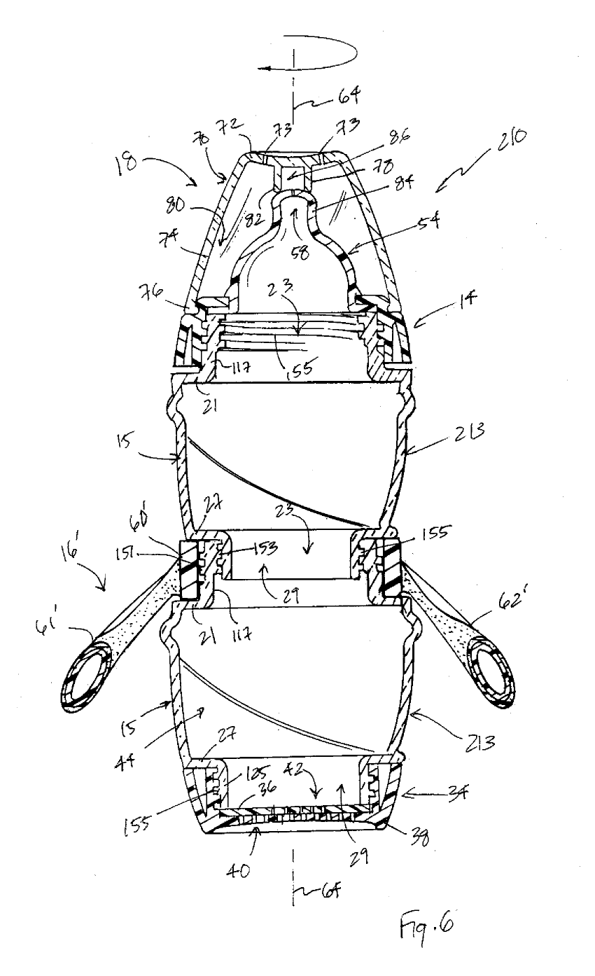

One example of a “kit” that could be used by a caregiver to custom make either a “short” bottle 10 of the type shown in FIG. 1 or a “tall” bottle 110 of the type shown in FIG. 5 is illustrated in FIG. 4. This kit comprises a pair of short sleeves 13 and a connector ring 33. Connector ring 33 includes an annular band 35, internal threads 37 and 39 on an inner wall of annular band 35, and an annular grip member 41 on an exterior wall of annular band 35. As suggested in FIGS. 4 and 5, connector ring 33 is configured to interconnect an upper short sleeve 13′ and a lower short sleeve 13″ by (1) mating internal threads 37 on annular band 35 with the external threads on bottom collar 25 of upper short sleeve 13′ and by (2) mating internal threads 39 on annular band 35 with the external threads on top collar 17 of lower short sleeve 13″.

Bottom closure 34 of container 12 comprises a valve 36 and a valve base 38. Valve base 38 is threaded to mate with sleeve 30 at the bottom end thereof to close bottom opening 32 and is formed to include an array 40 of vent apertures. Valve 36 is made of a pliable, sealing material and is formed to include an array 42 of vent apertures. Valve 36 is mounted in an interior region formed in valve base 38 for movement away from valve base 38 to a vented position opening the vent apertures in arrays 40 and 42 and toward valve base 38 to a sealed position closing the vent apertures in arrays 40 and 42. Valve 36 functions as a “one-way” diaphragm valve to allow ambient air to flow into an interior region 44 of sleeve 13 or 13′ through aperture arrays 40, 42 as an infant is fed when the bottle is “inverted” or “inclined” (not shown) and to block flow of air and liquid through aperture arrays 40, 42 when the bottle is upright as shown in FIGS. 1 and 5.

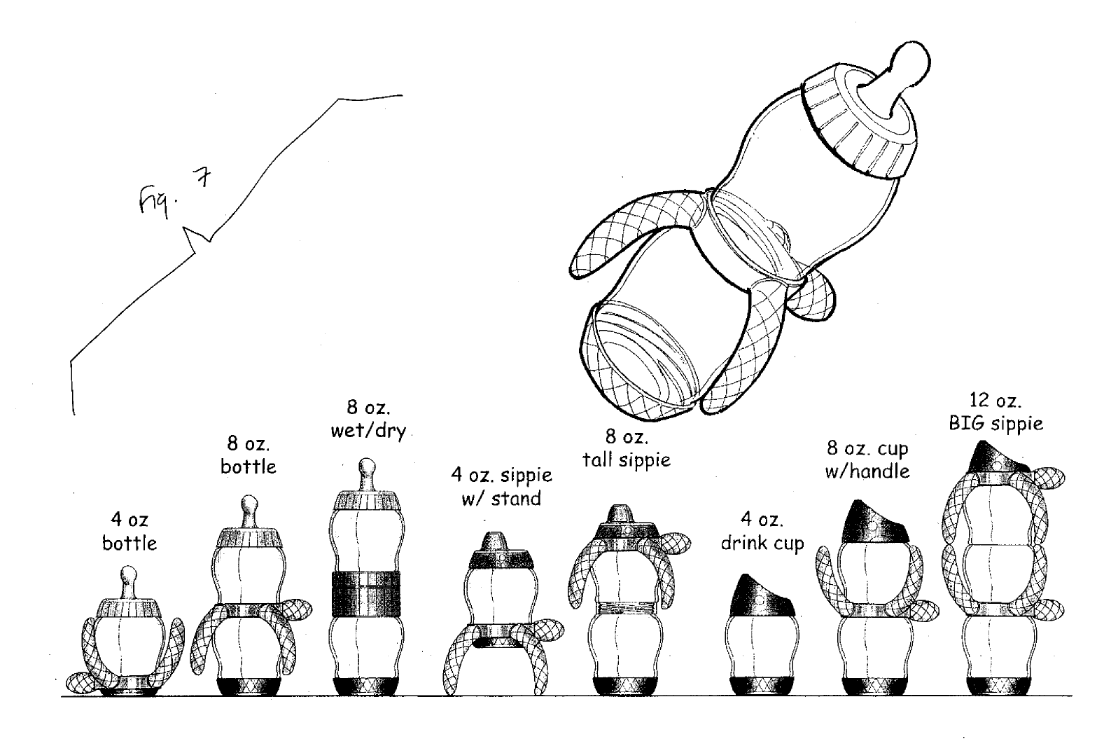

Liquid dispenser 14 includes a pliable nipple 54 and a nipple mount 56 as shown, for example, in FIGS. 1, 2, 5, and 6. A liquid-discharge aperture 58 is formed in nipple 52 as suggested in FIGS. 5 and 6. Nipple mount 56 is configure to mate with sleeve 13, 13′, or 113 at the upper end thereof to hold nipple 54 in a fixed position closing open mouth 31 and regulating discharge of liquid 11 from container 12. Alternative liquid dispensers suitable for use with container 12 in the present disclosure include a lid 101 and spout 102, as shown, for example, in FIG. 4.

Bottle holder 16 includes a mount ring 60 and a pair of grip handles 61, 62 coupled to mount ring 60 as shown, for example, in FIGS. 1, 4, and 5. Each of grip handles 61, 62 is arranged to lie at an angle 137 of about 37° with respect to a central axis 64 extending through bottle 10 as shown in FIG. 5. Mount ring 60 is sized and shaped to receive threaded collar 17 providing open mouth 23. In the embodiment of FIG. 5, mount ring 60 is sized and shaped to be trapped between sleeve 30 and nipple mount 56.

In an illustrative embodiment, a soft material (stippled pattern) is overmolded onto portions of grip handles 61, 62 to provide easy-to-hold, non-slip, soft external grip portions on grip handles 61, 62, It is within the scope of this disclosure to invert bottle holder (see, e.g., 116 in FIG. 4) and mount inverted bottle holder 116 in the manner suggested in FIG. 4. As shown in FIG. 5, bottle 110 is easy for an infant to hold during feeding, in part, owing to use of a “narrow-waisted” container 13′, 33, 13″ in container 12 along with splayed grip handles 61, 62 arranged to place the narrow-waist portion of container 12 therebetween.

In an embodiment of the present disclosure illustrated in FIG. 6, short sleeves 213 are configured to be connected to one another to form a tall bottle 210 without using connector ring 33. Each short sleeve 213 includes a somewhat barrel-shaped side wall 15, a top collar 117 appended to a top end 21 of barrel-shaped side wall 15, and a bottom collar 125 appended to a bottom end 27 of barrel-shaped side wall 15. Top collar 117 includes external threads 151 and internal threads 153. Bottom collar 125 includes external threads 155 configured to mate with internal threads 153 of top collar 117 as suggested in FIG. 6. It is within the scope of this disclosure to provide a suitable sealing ring or the like between the two interconnected short sleeves 113 to block liquid leakage at a joint between the two interconnected short sleeves 213.

In the embodiment of FIG. 6, mount ring 60′ of holder 16′ is configured to surround top collar 117 of the lower short sleeve 213. Mount ring 60′ is thus trapped between top end 21 of the lower short sleeve 213 and bottom end 27 of the upper short sleeve 213.

Bottle cap 18 includes a shell 70 having a ceiling 72 and a conical side wall 74 extending from ceiling 72 and terminating at an annular rim 76 adapted to mate with liquid dispenser 14 as suggested in FIGS. 1 and 4. Cap 18 also includes a drip container 78 located in an interior region 80 defined by shell 70 and arranged to depend from ceiling 72 as shown best in FIGS. 5 and 6. Drip container 78 is a cylinder-shaped side wall terminating at an annular rim 82 sized to mate with a tip 84 of nipple 54 and surround liquid-discharge opening 58 formed in nipple tip 84 as shown in FIGS. 5 and 6. When the bottle is inverted, any liquid droplets discharged through liquid-discharge opening 58 will pass into a liquid reservoir 86 formed in drip container 78. In the illustrated embodiment, ceiling 72 is formed to include one or more air vents 73 for venting air into interior region 80 of shell 70.

It is within the scope of this disclosure to provide modular kits containing many different combinations of components. These kits can be used by a caregiver to create a wide variety of liquid-dispensing bottles as shown, for example, in FIG. 7.

1. A liquid-dispensing bottle kit including components capable of being assembled in the field in one way to produce a small-volume bottle and in another way to produce a large-volume bottle, the liquid-dispensing bottle kit comprising
a first short sleeve,
a second short sleeve,
a connector ring formed to include means for interconnecting the first and second short sleeves,
a bottom closure configured to mate with each of the first and second short sleeves to close a bottom opening formed therein, and
a liquid dispenser configured to mate with each of the first and second short sleeves to close a top opening formed therein,
wherein the first sleeve is mated with the bottom closure and the interconnecting mans of the connector ring, the second sleeve is mated with the liquid dispenser and the interconnecting means of the connector ring to produce a tall large-volume bottle, and
wherein the first sleeve is mated with the bottom closure and the liquid dispenser to produce a short small-volume bottle that is shorter than the tall large-volume bottle.
